(19) United States
(12) Patent Application Publication
(10) Pub. No.: US 2026/0249827 A1
(43) Pub. Date: Aug. 27, 2026

(54) BRAKE CONTROL SYSTEM FOR A VEHICLE

(71) Applicant: ZF Active Safety GmbH, Koblenz (DE)

(72) Inventors: Patrick MUELLER, Mayen (DE); Nebojsa MARKOVIC, Bendorf (DE); Florian GERHARTZ, Büchel (DE)

(21) Appl. No.: 19/540,884

(22) Filed: Feb. 16, 2026

(30) Foreign Application Priority Data
Feb. 25, 2025 (DE) 102025107003.2
Oct. 21, 2025 (DE) 102025143077.2

(51) Int. Cl. B60T 13/74; B60T 7/04; B60T 8/17; B60T 8/171; B60T 13/66; F16D 65/18

(52) U.S. Cl. CPC B60T 13/741; B60T 7/042; B60T 8/1703; B60T 8/171; B60T 13/662; F16D 65/18

(57) ABSTRACT

A brake control system for controlling an electric motor of a brake force generator includes a first motor control system having a first supply line, a first control bridge, and first control electronics to control the first control bridge as a function of an externally preset control signal such that the same provides a first motor control signal for controlling the electric motor. A second motor control system has a second supply line, a second control bridge, and second control electronics to control the second control bridge as a function of an externally preset control signal such that the same provides a second motor control signal for controlling the electric motor if the electric motor is not being controlled with the first motor control signal. A braking system for a vehicle and a method for operating a brake control system are described.

### TECHNICAL FIELD

The invention relates to a brake control system for a vehicle for controlling an electric motor of a brake force generator. The invention also relates to a method for operating the brake control system and to a braking system for a vehicle.

### BACKGROUND

Braking systems for vehicles known from the prior art are typically designed in a redundant manner in order to reduce the risk of failure.

For example, there are hydraulic braking systems which have a main brake module with an electrofluidic pressure generator, using which a brake pressure is generated based on an electrical brake signal. The brake pressure acts on a hydraulic actuator unit, which generates a corresponding braking force which then brakes at least one of the wheels of the vehicle via hydraulic brake actuators. In order to ensure that there is no loss of braking force due to faults, for example problems in the control of the electrofluidic pressure generator, such so-called “brake-by-wire” systems typically have a second brake module, which can provide the brake pressure in the event of a defect in the main brake module. The second brake module is a conventional hydraulic brake module for example, in which the brake pressure is provided by actuating a brake pedal and is optionally increased.

In addition, there are for example electromechanical braking systems which, in accordance with the “brake-by-wire” principle, have electromechanical brake actuators assigned to the wheels of the vehicle, by means of which a braking force for braking the vehicle can be generated for at least one of the wheels of the vehicle based on an electrical brake signal.

### SUMMARY

To realize such braking systems, a large number of individual components are required, for example a plurality of brake actuators or brake cylinders as well as valves, in order to hydraulically couple the second brake module with the actuator unit if required. The redundantly designed braking systems, which are known from the prior art, are therefore for the most part technically complex and expensive to manufacture.

It is therefore the object of the invention to provide a device, using which a braking force can be generated in a technically simple and reliable manner.

The object is achieved by a brake control system for a vehicle for controlling an electric motor of a brake force generator. The brake control system comprises a first motor control system having a first supply line for providing a power supply for the electric motor, a first control bridge connected to the first supply line, and having first control electronics, which are designed to control the first control bridge as a function of an externally preset control signal such that the same provides a first motor control signal for controlling the electric motor. The brake control system further comprises a second motor control system having a second supply line for providing a power supply for the electric motor, a second control bridge connected to the second supply line, and having second control electronics, which are designed to control the second control bridge as a function of an externally preset control signal such that the same provides a second motor control signal for controlling the electric motor if the electric motor is not being controlled with a first motor control signal provided by the first motor control system.

The basic idea of the invention consists in providing at least two mutually independent motor control systems in order to be able to control the electric motor of a brake force generator with the help of the other motor control system in the event of a defect in one of the motor control systems. Thus, in simple terms, instead of a large number of components, only the electrical or electronic components are designed redundantly in order to be able to provide the braking force in a technically simple and reliable way. It has been shown that the electric motor of the brake force generator itself can be designed in a very robust and fault-free manner, which is why it is preferably possible to dispense with the provision of a second electric motor.

The second motor control signal for controlling the electric motor is provided by means of the second motor control system when the electric motor is not being controlled by the first motor control system using a first motor control signal. This case can occur in particular when no first motor control signal at all is provided by the first motor control system due to a defect or when a faulty first motor control signal is output by the first motor control system, with which the electric motor cannot be controlled such that a braking force of a desired level is provided.

It is for example possible to determine whether the electric motor is properly controlled by the first motor control system using a first motor control signal by means of a current measurement and/or speed measurement at the electric motor.

One aspect of the invention provides that that the first motor control system has a first switch, which can be switched by the first control electronics, for optionally interrupting and producing the power supply of the electric motor via the first supply line and that the second motor control system has a second switch, which can be switched by the second control electronics, for optionally interrupting and producing the power supply of the electric motor via the second supply line. The first and second motor control systems can easily be switched on or off by actuating the corresponding switch if required.

For example, the first switch can be switched by the second control electronics. Alternatively or in addition, the second switch can be switched by the first control electronics. For example, if the control electronics in one of the motor control systems fail or no longer function properly, the control electronics of the respective other motor control system can thus intervene and cause the switch of the defective motor control system to be opened. This allows the defective motor control system to be deactivated even if self-deactivation by the system-internal control electronics is not possible.

In a further variant of the brake control system, it is provided that the first switch and the second switch are connected to each other by a two-way and/or cross connection. The two-way and/or cross connection can be realized by hardware components or alternatively designed as a purely logical circuit. By means of the two-way and/or cross connection, it is possible in a technically simple and reliable way to ensure that in the event of a deactivation of one of the motor control systems, the other motor control system is automatically activated and vice versa.

Another aspect of the invention provides that the first motor control system comprises a first communication bus for transmitting control signals to the first control electronics and that the second motor control system comprises a second communication bus for transmitting control signals to the second control electronics. The control signals can be transmitted to the respective control electronics in a technically simple way by means of the communication buses. Since the two motor control systems each have a separate communication bus, the brake control system as a whole is particularly fail-safe.

In a preferred design variant, the first communication bus and the second communication bus are connected to each other in such a way that information about a state of the first motor control system can be transmitted from the first control electronics to the second control electronics and/or information about a state of the second motor control system can be transmitted from the second control electronics to the first control electronics. If a problem or a fault in the first motor control system is for example detected by the first control electronics, information about it can be transmitted to the second control electronics via the communication buses. The second control electronics can then cause the motor control to be taken over by the second motor control system.

It may also be provided that the second control electronics is designed to detect first motor control signals provided by the first motor control system. The second control electronics can detect the first motor control signals, for example on the basis of a current measurement and/or speed measurement, in particular at the electric motor. In the event that no or only a faulty first motor control signal is detected by the second control electronics, the second control electronics can cause the motor control to be taken over by the second motor control system and the first motor control system is deactivated.

In principle, the second control electronics can control the second control bridge for taking over the motor control in such a way that the same provides a second motor control signal which is in phase with a previously detected first motor control signal. This makes it possible to change the motor control system during continuous operation of the electric motor. Therefore, if a sudden fault occurs in the first motor control system during operation, the electric motor does not have to be stopped so that the second motor control system can take over the control.

Alternatively or additionally, the first control electronics may be designed to detect second motor control signals provided by the second motor control system. As a result, it is for example possible to check in a test mode whether the second system is functioning properly and can take over the motor control in the event of a fault in the first motor control system.

The object is also achieved according to the invention by a braking system for a vehicle. The braking system comprises a brake force generator with an electric motor for optionally actuating at least one brake actuator for braking at least one wheel of the vehicle, and a brake control system according to the invention for controlling the electric motor.

According to a first embodiment, the braking system is a hydraulic braking system, wherein the brake force generator is a brake pressure generator and actuation of the brake actuator by pressurization and pressure relief takes place hydraulically. Hydraulic brake actuators are used for this.

According to a second embodiment, the braking system is an electromechanical braking system, wherein an actuation of the brake actuator by the electric motor of the brake force generator takes place electromechanically. Electromechanical brake actuators are used for this.

The advantages which were discussed for the brake control system apply for the braking system in the same way.

In a preferred variant, the braking system further comprises a first electrical energy storage device which is connected to the first supply line and a second electrical energy storage device which is connected to the second supply line. In other words, separate energy storage devices are therefore provided for controlling the electric motor by means of the first motor control system and for controlling the electric motor by means of the first motor control system. Should one of the energy storage devices fail, then energy can still be supplied via the other energy storage device in each case for motor control and thus brake force generation, which increases the system reliability overall.

The object of the invention is also achieved by a method for operating a brake control system according to the invention. The method comprises the steps: Determining whether a first motor control signal is provided by the first motor control system for controlling the electric motor; and providing a second motor control signal for controlling the electric motor by means of the second motor control system when it has been determined that no first motor control signal is provided by the first motor control system for controlling the electric motor.

Of course, the advantages that have been discussed for the brake control system likewise apply for the method.

In principle, controlling of the electric motor can then take place by means of the second motor control system even if the first motor control system is functioning properly. For example, the second motor control system can take over the control of the electric motor in a test operation to check whether it is functioning properly and, in the event of a fault in the first motor control system, can take over the motor control.

### BRIEF DESCRIPTION OF THE DRAWINGS

Further features and advantages of the invention will become apparent from the following description and from the accompanying drawings, to which reference is made in the following. In the drawings:

FIG. 1 shows a schematic illustration of a vehicle with an exemplary embodiment of a braking system according to the invention; and

FIG. 2 shows a schematic illustration of a brake control system according to the invention

### DESCRIPTION

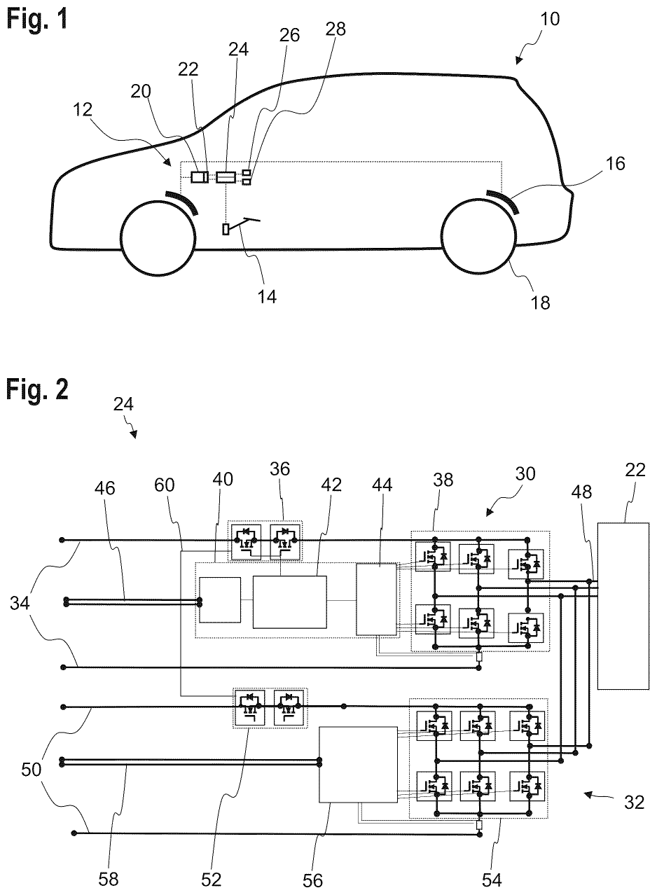

FIG. 1 shows a vehicle 10 with an exemplary embodiment of a braking system 12 according to the invention.

A braking system 12 according to the invention comprises a brake signal transmitter 14, for example a brake pedal, using which a driver can specify a desire to brake. In other words, the driver can therefore request a defined deceleration torque for braking the vehicle 10 by means of the brake signal transmitter 14.

Furthermore, a braking system 12 according to the invention comprises a plurality of brake actuators 16. Each of the brake actuators 16 is assigned to a wheel 18 of the vehicle 10 and designed to generate a braking force in order to brake the wheel 18 in question as a function of the deceleration torque requested.

The exemplary embodiment shows a hydraulic braking system 12 with hydraulically actuable brake actuators 16. To actuate the hydraulic brake actuators 16, the braking system 12 comprises at least one brake pressure generator 20 with an electric motor 22 as a brake force generator, using which a braking force for the brake actuators 16 can be provided by optional pressurization and pressure relief. In the exemplary embodiment shown in FIG. 1, the electric motor 22 is designed as a brushless three-phase AC machine.

In the case of an electromechanical braking system with electromechanically actuable brake actuators—not illustrated here—an electromechanical brake actuator would be actuated by the electric motor of an associated brake force generator unit. For this, the brake force generator unit would, in a known manner, comprise at least one intermediate gear mechanism, in particular a screw gear mechanism, to convert a rotary movement of the electric motor into a linear movement for actuating the brake actuator.

In addition, the braking system 12 comprises a brake control system 24 for controlling the electric motor 22 and a first electrical energy storage device 26 and a second electrical energy storage device 28. The energy storage devices 26, 28 are used to supply the electric motor 22 with electrical energy. More precisely, the energy provided by the energy storage devices 26, 28 can be used to provide a motor control signal by means of the brake control system 24, using which the electric motor 22 is driven. For example, the energy storage devices 26, 28 can be mutually independent batteries of the vehicle 10.

FIG. 2 shows a schematic illustration of the brake control system 24.

The brake control system 24 comprises a first motor control system 30 and a second motor control system 32 for controlling the electric motor 22.

The first motor control system 30 comprises a first supply line 34 which is connected to the first energy storage device 26 and via which the electrical energy for operating the electric motor 22 can be provided.

A first switch 36 is arranged in the first supply line 34, using which the power supply of the electric motor 22 can be optionally interrupted or produced via the first supply line 34.

Furthermore, the first motor control system 30 comprises a first control bridge 38, which is connected to the first supply line 34, and first control electronics 40, which are designed to control the first control bridge 38 in such a way, as a function of an externally preset control signal, that the same provides a first motor control signal for controlling the electric motor 22.

In addition, by means of the first control electronics 40, the first switch 36 can optionally be opened or closed, in order thus to control the power supply for the electric motor 22 or the provision of the first motor control signal.

In the embodiment shown in FIG. 2, the first control electronics 40 comprise a computing unit 42 and a memory 44, in which program codes are stored, which can be executed by the computing unit 42, for example motor drivers and/or diagnostic software, in particular with runtime error detection, by means of which the computing unit 42 can check whether the first motor control system 30 is functioning properly.

The control signal that is externally preset is for example an electrical signal coming from the brake signal generator 14, which characterizes the requested deceleration torque.

In addition, the first motor control system 30 comprises a first communication bus 46 which is used to transmit the externally preset control signal to the first control electronics 40. For example, the first communication bus 46 can be a CAN bus.

When, in normal operation of the brake control system 24, a corresponding control signal is transmitted via the first communication bus 46 to the first control electronics 40, the first control electronics 40 control the first control bridge 38 in such a way that the same provides a first motor control signal. The first motor control signal is for example a three-phase alternating-current signal which is transmitted from the first control bridge 38 via three phase conductors 48 to the electric motor 22 in order to drive the same.

The second motor control system 32 is used to take over the function of the first motor control system 30 and to control the electric motor 22 when the first motor control system 30 is not functioning properly, for example if there are problems with the power supply via the first supply line 34 and the first switch 36 and/or problems with the control of the first control bridge 38 by the first control electronics 40.

The second motor control system 32 may be constructed identically or at least similarly to the first motor control system 30.

The second motor control system 32 comprises a second supply line 50, which is connected to the second energy storage device 28 and can be provided by means of the electrical energy for operating the electric motor 22.

A second switch 52 is arranged in the second supply line 50, using which the power supply of the electric motor 22 can be optionally interrupted or produced via the second supply line 50.

Furthermore, the second motor control system 32 comprises a second control bridge 54, which is connected to the second supply line 50, and second control electronics 56, which are designed to control the second control bridge 54 in such a way, as a function of an externally preset control signal, that the same provides a second motor control signal for controlling the electric motor 22.

In addition, by means of the second control electronics 56, the second switch 52 can optionally be opened or closed and thus control the power supply for the electric motor 22 or the provision of the second motor control signal.

The second control electronics 56 of the second motor control system 32 can have the same design and the same program codes as the first control electronics 40 of the first motor control system 30. Alternatively, the second control electronics 56 may also comprise fewer or different components and/or program codes compared to the first control electronics 40. In simple terms, the second control electronics 56 can therefore be designed to be slimmer than the first control electronics 40, since they are only used to take over the motor control in the event of a fault in the first motor control system 30.

In addition, the second motor control system 32 comprises a second communication bus 58 which is used to transmit the externally preset control signal to the second control electronics 56. For example, the second communication bus 58 can also be a CAN bus.

When, in the event of a fault in the first motor control system 30 for example, a corresponding control signal is transmitted via the second communication bus 58 to the second control electronics 56, the second control electronics 56 control the second control bridge 54 in such a way that the same provides a second motor control signal. The second motor control signal is for example a three-phase alternating-current signal which is transmitted from the second control bridge 54 via the three phase conductors 48 to the electric motor 22 in order to drive the same.

It is special in the embodiment shown in FIG. 2 that the first switch 36 of the first motor control system 30 can be switched by the second control electronics 56. If there is a problem with the motor control via the first motor control system 30 and this is detected by the second control electronics 56, the second control electronics 56 can deactivate the first motor control system 30 by actuating the first switch 36 and get control of the electric motor 22 via the second control bridge 54 underway.

The first switch 36 and the second switch 52 are also connected to each other by a cross connection 60. The cross connection 60 is designed in the exemplary embodiment as a virtual circuit and realized by a program code. For example, when the first switch 36 is actuated by the second control electronics 56 in order to deactivate the first motor control system 30, the second switch 52 is also simultaneously actuated via the virtual circuit to activate the second motor control system 32.

The first communication bus 46 and the second communication bus 58 are optionally connected to each other, so that information can be transmitted via the two buses 46, 58 between the first control electronics 40 and the second control electronics 56. In particular, it is possible via the two buses 56, 58 to transmit information about the state of the first motor control system 30 from the first control electronics 40 to the second control electronics 56 and to transmit information about a state of the second motor control system 32 from the second control electronics 46 to the first control electronics 40. By this exchange of information the second control electronics 56 can for example determine whether a problem is present in the control of the electric motor 22 by means of the first motor control system 30 and optionally take over the motor control.

In addition, the second control electronics 56 are designed to detect first motor control signals provided by the first motor control system 30, for example on the basis of a current measurement and/or speed measurement at the phase conductors 48. Thus, the second control electronics 56 can then themselves determine whether proper control of the electric motor 22 is taking place via the first motor control system 30 if no information about the state of the first motor control system 30 is transmitted to the second control electronics 56 via the communication buses 46, 58.

Optionally, the first control electronics 40 may also be designed to detect second motor control signals provided by the second motor control system 32. As a result, in a test operation in which the electric motor 22 is controlled by the second motor control system 32, it can for example be determined by the first control electronics 40 whether the control is functioning properly.

The brake control system 24 shown in FIG. 2 is operated using an exemplary embodiment of a method according to the invention, which is briefly explained below.

In a first step of the method, the second control electronics 56 of the second motor control system 32 determine whether a first motor control signal for controlling the electric motor 22 is provided by the first motor control system 30. This can take place for example on the basis of a current measurement and/or speed measurement at the phase conductors or by means of information transmission via the communication buses 46, 58.

In a second step of the method, the second control electronics 56 control the second control bridge 54 in such a way that the same provides a second motor control signal for controlling the electric motor 22, if it has been determined in the preceding first step that no first motor control signal for controlling the electric motor 22 is provided by the first motor control system 30.

1. Brake control system for a vehicle for controlling an electric motor of a brake force generator, comprising
a first motor control system having a first supply line for providing a power supply for the electric motor, a first control bridge connected to the first supply line, and having first control electronics, which are designed to control the first control bridge as a function of an externally preset control signal such that the same provides a first motor control signal for controlling the electric motor; and
a second motor control system having a second supply line for providing a power supply for the electric motor, a second control bridge connected to the second supply line, and having second control electronics, which are designed to control the second control bridge as a function of an externally preset control signal such that the same provides a second motor control signal for controlling the electric motor if the electric motor is not being controlled with a first motor control signal provided by the first motor control system.

2. Brake control system according to claim 1, wherein the first motor control system has a first switch, which can be switched by the first control electronics, for optionally interrupting and producing the power supply of the electric motor via the first supply line and wherein the second motor control system has a second switch, which can be switched by the second control electronics, for optionally interrupting and producing the power supply of the electric motor via the second supply line.

3. Brake control system according to claim 2, wherein the first switch can be switched by the second control electronics and/or wherein the second switch can be switched by the first control electronics.

4. Brake control system according to claim 2, wherein the first switch and the second switch are connected to each other by a two-way and/or cross connection.

5. Brake control system according to claim 1, wherein the first motor control system comprises a first communication bus for transmitting control signals to the first control electronics and wherein the second motor control system comprises a second communication bus for transmitting control signals to the second control electronics.

6. Brake control system according to claim 5, wherein the first communication bus and the second communication bus are connected to each other in such a way that information about a state of the first motor control system can be transmitted from the first control electronics to the second control electronics and/or information about a state of the second motor control system can be transmitted from the second control electronics to the first control electronics.

7. Brake control system according to claim 1, wherein the second control electronics are designed to detect first motor control signals provided by the first motor control system and/or wherein the first control electronics are designed to detect second motor control signals provided by the second motor control system.

8. Braking system for a vehicle, comprising
a brake force generator with an electric motor for optionally actuating at least one brake actuator for braking at least one wheel of the vehicle; and
a brake control system according claim 1, for controlling the electric motor.

9. Braking system according to claim 8, wherein the brake force generator is a brake pressure generator and actuation of the brake actuator by pressurization and pressure relief takes place hydraulically.

10. Braking system according to claim 8, wherein an actuation of the brake actuator by the electric motor of the brake force generator takes place electromechanically.

11. Braking system according to claim 8, further comprising a first electrical energy storage device which is connected to the first supply line and a second electrical energy storage device which is connected to the second supply line.

12. Method for operating a brake control system according to claim 1, comprising the steps:
determining whether a first motor control signal is provided by the first motor control system for controlling the electric motor; and
providing a second motor control signal for controlling the electric motor by means of the second motor control system when it has been determined that no first motor control signal is provided by the first motor control system for controlling the electric motor.
